(19) United States
(12) Patent Application Publication
(10) Pub. No.: US 2006/0257169 A1
(43) Pub. Date: Nov. 16, 2006

(54) PREPARATORY DEVELOPING SOLUTION CONTAINER FOR WET TYPE IMAGE FORMING APPARATUS

(75) Inventors: Hiroyuki Saito, Tokyo (JP); Hidetaka Yamaguchi, Tokyo (JP); Masatoshi Takano, Tokyo (JP); Motohiro Maseki, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/382,817

(22) Filed: May 11, 2006

(30) Foreign Application Priority Data
May 12, 2005 (JP) P2005139300

(51) Int. Cl. G03G 15/10

(52) U.S. Cl. 399/238

(57) ABSTRACT

A wet type image forming apparatus having a developing solution container a preparatory developing solution container, which is adapted to store developing solution to be supplied to the developing solution container, and an attachment unit to which the preparatory developing solution container is attached, is provided. The preparatory developing solution container includes a coupling portion removably coupled to the attachment unit, a developing solution path being formed in the coupling portion to allow the developing solution to flow therein, a blocking system blocking the developing solution path, and a stirring unit stirring the developing solution in the preparatory developing solution container. The attachment unit includes a releasing system to open the developing solution path blocked by the blocking system when the coupling portion of the preparatory developing solution container is coupled to the attachment unit.

### BACKGROUND OF THE INVENTION

The present invention relates to a wet type image forming apparatus equipped with a preparatory developing solution container for storing developing solution that is to be supplied to another developing solution container.

Apparatuses to form an image on a recording sheet by employing an electrophotographic technique include, for example, a dry type image forming apparatus, which applies powder toner to a surface of a developing roller to form an image, and a wet type image forming apparatus, which applies developing solution containing toner in carrier solution to a surface of a developing roller to form an image. The toner used in the latter apparatus is generally finer than that employed in the former. Accordingly, the latter provides an image of a higher quality.

A conventional wet type image forming apparatus is generally equipped with a developing solution container, and developing solution therein is supplied to a developing device during an image forming operation. In such a wet type image forming apparatus, color density of an image being formed depends on density of the toner in the developing solution. As the image is formed, quantity of the developing solution in the container decreases. Therefore, as disclosed in Japanese Patent Provisional Publication No. P2002-278294A, the wet type image forming apparatus is provided with a preparatory solution container so that developing solution therein is supplied to the developing solution container when the quantity of the developing solution in the developing solution container decreases.

When the image forming apparatus with the preparatory solution container is left unused for a long period of time, the developing solution in the preparatory solution container tends to be separated into a layer containing only carrier solution and a layer containing high-density toner, which may affect the color density of the image to be formed. In order to avoid the separation of the developing solution, the image forming apparatus in the above-referenced publication is provided with a stirrer in the preparatory solution container, and the preparatory solution container is fixed to a body of the image forming apparatus so that the stirrer is securely positioned in the preparatory solution container. With this configuration, the preparatory solution container is exchangeable even when the developing solution therein is used up, and new developing solution must be refilled in the preparatory solution container. Therefore, during such a refilling operation, the body of the image forming apparatus and/or hands of an operator are often contaminated by the developing solution. Further, when a new kind of developing solution is used in the image forming apparatus, the developing solution remaining in the preparatory solution container is required to be completely removed, so that the different kinds of developing solutions may not be mixed. However, removing the remaining developing solution from the fixed preparatory solution container is difficult.

### SUMMARY OF THE INVENTION

In view of the foregoing situation, the present invention is advantageous in that an improved wet type image forming apparatus with a preparatory solution container, in which an operation to remove residual developing solution is not required, is provided. Further, the improved wet type image forming apparatus, wherein the body thereof and/or hands of the operator are not contaminated by the developing solution, during an replacing operation of the preparatory solution container, is provided.

According to an aspect of the invention, there is provided a wet type image forming apparatus having a developing solution container a preparatory developing solution container, which is adapted to store developing solution to be supplied to the developing solution container, and an attachment unit to which the preparatory developing solution container is attached, is provided. The preparatory developing solution container includes a coupling portion removably coupled to the attachment unit, a developing solution path being formed in the coupling portion to allow the developing solution to flow therein, a blocking system blocking the developing solution path, and a stirring unit stirring the developing solution in the preparatory developing solution container. The attachment unit includes a releasing system to open the developing solution path blocked by the blocking system when the coupling portion of the preparatory developing solution container is coupled to the attachment unit.

Optionally, the blocking system may include a movable sealing member being adapted to block the developing solution path, and an expansive member being adapted to apply expanding force to the movable sealing member so that the movable sealing member with the expanding force blocks the developing solution path.

Optionally, the releasing system may be adapted to shift the movable sealing member against the expanding force of the expansive member so that the developing solution path is opened.

Optionally, the stirring unit may include at least one paddle to stir the developing solution in the preparatory developing solution container, and a rotary shaft to which the at least one paddle is attached. The at least one paddle may be adapted to be unfolded according a rotation of the rotary shaft in one direction, and folded according to a rotation of the rotary shaft in an opposite direction.

Optionally, an outer diameter of a circular area in a plane perpendicular to an axis of the rotary shaft, within which the stirring unit with the paddles folded fit, may be configured to be smaller than an inner diameter of the coupling portion.

Optionally, the stirring unit may include at least one paddle to stir the developing solution in the preparatory developing solution container, and a rotary shaft to which the at least one paddle is attached. The attachment unit may include a drive force transmitting system to transmit drive force generated in the wet type image forming apparatus to the rotary shaft.

Optionally, the rotary shaft may include a first shaft having the at least one paddle attached thereto, a second shaft, of which an end portion is exposed from an opening formed in the coupling portion, being slidable in an axial direction of the first shaft, and an expansive member applying an expanding force to the second shaft toward the opening. The drive force transmitting system may be adapted to engage with the second shaft and to press the second shaft in an axial direction of the second shaft against the expanding force from the expansive member when the preparatory developing solution container is attached to the attachment unit so that the drive force via the drive force transmitting system is transmitted to the rotary shaft.

Optionally, the second shaft may be provided with a sealing member that is applied the expanding force by the expansive member to block the developing solution path. The second shaft may be shifted to open the developing solution path when the drive force transmitting system is engaged with the second shaft.

According to aspects of the invention, there is provided a developing solution container to store developing solution therein for a wet type image forming apparatus, having a coupling portion, which is removably coupled to an attachment unit of the wet type image forming apparatus, a developing solution path, which is formed in the coupling portion to allow the developing solution to flow therein, a blocking system, which is adapted to block the developing solution path, and a stirring unit, which is adapted to stir the developing solution in the developing solution container. The developing solution path is blocked when the developing solution container is attached to the attachment unit of the wet type image forming apparatus, and is opened when the developing solution container is removed from the attachment unit of the wet type image forming apparatus.

### BRIEF DESCRIPTION OF THE ACCOMPANYING DRAWINGS

FIG. 1 is a cross-sectional side view showing a structure of a wet type printer according to an embodiment of the present invention.

FIG. 2 is another cross-sectional side view of the wet type printer taken from a rear side thereof according to the embodiment of the present invention.

FIG. 3 is an illustrative diagram of a preparatory solution container of the wet type printer according to the embodiment of the present invention.

FIG. 4 is an enlarged side view showing a rotary shaft of the preparatory solution container of the wet type printer according to the embodiment of the present invention.

FIG. 5 is a cross-sectional side view showing a structure of a receiver unit of the wet type printer according to the embodiment of the present invention.

FIG. 6A is an enlarged perspective view of a lower end portion of a drive force transmitting shaft, and FIG. 6B is an enlarged perspective view of an upper end portion of a drive shaft according to the embodiment of the present invention.

FIG. 7 is a cross-sectional side view showing a structure of the preparatory solution container mounted to the receiver unit according to the embodiment of the present invention.

FIGS. 8A and 8B are cross-sectional top views showing an internal structure of the preparatory container with a paddle unit therein according to the embodiment of the present invention.

### DETAILED DESCRIPTION OF THE EMBODIMENTS

Referring to the accompanying drawings, a wet type printer according to an embodiment of the present invention will be described in detail.

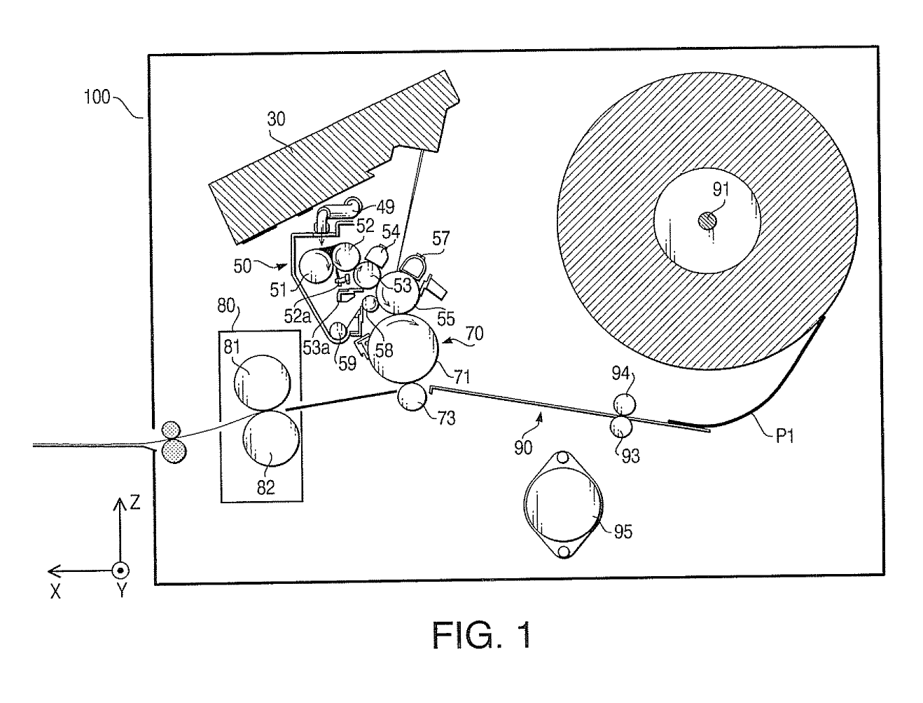

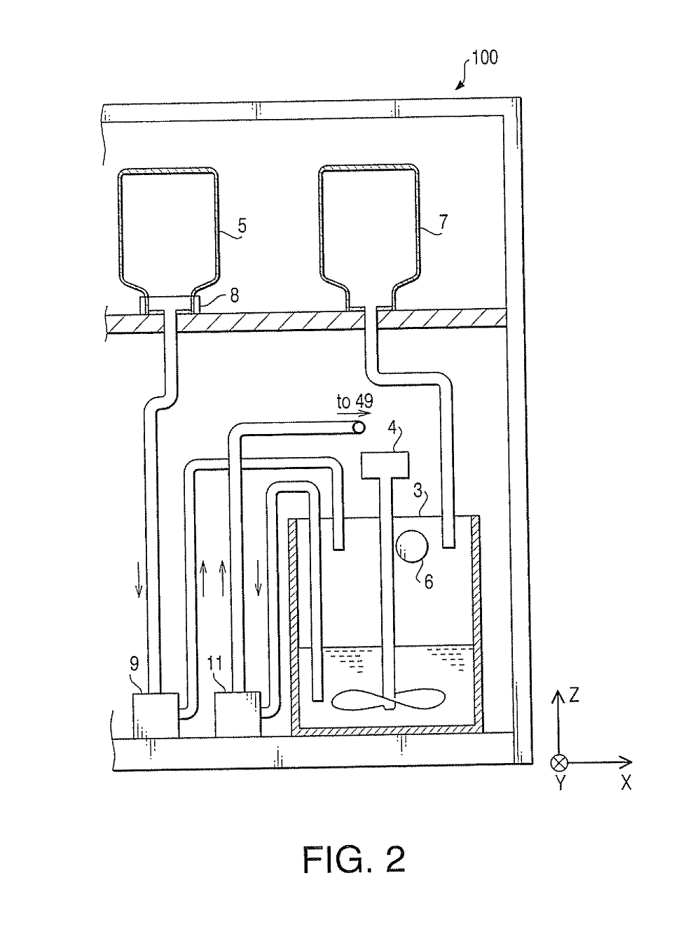

FIG. 1 is a cross-sectional side view showing a structure of a wet type printer according to an embodiment of the present invention. The wet type printer 100 is an apparatus for forming an image using developing solution that contains toner in carrier solution, and more specifically an apparatus that receives print information (i.e., character and/or image information) from an external apparatus such as a computer, and prints out the characters or the images on a sheet of recording paper P1 in accordance with a so-called electrophotographic imaging process. FIG. 2 is another cross-sectional side view of the wet type printer 100 taken from a rear side thereof according to the embodiment of the present invention.

The wet type printer 100 includes a laser scanning unit (hereinafter abbreviated as “LSU”) 30 that outputs a laser beam modulated according to print information, a developing unit 50 that develops a latent image formed on a photoconductive drum 55 according to the print information with the developing solution in the electrophotographic method, a feeding unit 90 that feed the recording paper P1, a transfer unit 70 that transfers a toner image developed by the developing unit 50 at a transfer position onto the recording paper P1, and a fixing unit 80 that permanently fixes the toner image that has been transferred on the recording paper P1.

The developing unit 50 includes an add roller 51, a measuring roller 52, an adjusting blade 52a, a developing roller 53, a developing roller cleaning blade 53a, a developing roller corona charger 54, the photoconductive drum 55, a photoconductive drum corona charger 57, a squeeze roller 58, and a screw 59. The measuring roller 52 is provided to measure amount of the developing solution on a surface thereof. The adjusting blade 52a evenly adjusts thickness of the developing solution on the surface of the measuring roller 52. The developing roller 53 carries the developing solution supplied from the measuring roller 52. The developing roller cleaning blade 53a scrapes off excessive amount of the developing solution from the surface of the developing roller 53. The developing roller corona charger 54 charges the surface of the developing roller 53. A surface of the photoconductive drum 55 is formed the latent image by the laser beam from the LSU 30. The photoconductive drum corona charger 57 uniformly charges the surface of the photoconductive drum 55. The squeeze roller 58 collects used developing solution from the surface of the photoconductive drum 55. And a screw 59 transmits residual developing solution collected in the developing unit 50 to the solution container 3 (see FIG. 2). All of rotation axes of the respective rollers are in parallel with each other and are perpendicular to a direction parallel to a plane of FIG. 1, although rotating directions of the respective rollers may vary.

When the image is formed, the developing solution stored in the solution container 3 is injected and the injected developing solution is transitionally pooled in a pit portion formed by the add roller 51 that rotates in a clockwise direction in FIG. 1 and the measuring roller 52 that rotates in a counterclockwise direction in FIG. 1. Thereafter, the developing solution is supplied to a surface of the measuring roller 52 by the rotation of the measuring roller 52. The supplied developing solution is partially scraped off and thereby adjusted by the adjusting blade 52a of which an edge is in contact with the surface of the measuring roller 52 so that excessive amount of the developing solution is removed. Thus, the remaining developing solution on the surface of the measuring roller 52 is transferred evenly to a surface of the developing roller 53, which is in contact with the measuring roller 52.

The photoconductive drum 55 has the surface constituted of a conductive material, so that such surface is uniformly charged by a corona charging effect of the developing roller corona charger 57. On the surface of the photoconductive drum 55, a latent image corresponding to the print information is formed, by the laser beam emitted from the LSU 30. The photoconductive drum 55 is charged so as to gain a higher potential than that of the developing roller 53, by the photoconductive drum corona charger 57. However, the region where the latent image is formed gains a lower potential than the developing roller 53, due to an effect of the laser beam. Accordingly, between the region excluding the latent image on the photoconductive drum 55 and the surface of the developing roller 53, the toner remains closely stuck to the lower-potential region, i.e. the surface of the developing roller 53, without being transferred to the region where no latent image exists. Consequently, the region excluding the latent image is not developed. By contrast, between the latent image region on the surface of the photoconductive drum 55 and the surface of the developing roller 53, the toner performs electrophoresis toward the lower-potential region, i.e. the latent image region on the surface of the photoconductive drum 55, thus to adhere thereto. That is how the latent image on the photoconductive drum 55 is developed, to turn into a toner image.

The toner image developed on the surface of the photoconductive drum 55 is transferred to the recording paper P1 by the transfer unit 70. The transfer unit 70 includes an intermediate transfer roller 71 and a secondary transfer roller 73.

To the intermediate transfer roller 71, a transfer bias of a reverse polarity to the toner is applied, so that the toner image developed on the surface of the photoconductive drum 55 is transferred as a primary step to the intermediate transfer roller 71, at the interface between the photoconductive drum 55 and the intermediate transfer roller 71.

The intermediate transfer roller 71 and the secondary transfer roller 73 are disposed so as to oppose to each other across a paper path for the recording paper P1, and mutually abut at a predetermined nip pressure. The toner image transferred to the surface of the intermediate transfer roller 71 is transferred to the recording paper P1 being carried along the paper path at the interface with the secondary transfer roller 73, by the effect of a transfer electric field, the nip pressure and so on.

The recording paper P1 on which the toner image has been transferred is carried to the fixing unit 80 along the paper path. The fixing unit 80 serves to apply heat and pressure to the recording paper P1, so as to fix the toner image onto the recording paper P1, and includes a heat roller 81 that heats up the recording paper P1, and a press roller 82 located opposing to the heat roller 81 across the paper path, so as to hold the recording paper P1 in cooperation with the heat roller 81, thus to apply a pressure to the recording paper P1.

The feeding unit 90 includes a core roller 91, around which the recording paper P1 as a continuous form recording sheet is rolled, a feed roller 93, which carries the recording paper P1, a subsidiary feed roller 94, which is rolled accordingly to rotation of the feed roller 93 to carry the recording paper P1, and a drive motor 95, which supplies rotating force to the feed roller 93.

Next, referring to FIG. 2, the solution container 3, to store the developing solution therein, will be described. The wet type printer 100 in the present embodiment includes a solution container 3, wherein developing solution is stored, a preparatory solution container 5, a preparatory carrier solution container 7, a supplier pump unit 9, and a conveyer pump unit 11. The preparatory solution container 5 stores therein preparatory developing solution, which is supplied to the solution container. Carrier solution is stored in the preparatory carrier solution container 7, and is supplied to the solution container 3. The supplier pump unit 9 is used to transmit the preparatory developing solution in the preparatory solution container 5 to the solution container 3.

During a printing operation of the wet type printer 100, the developing solution in the solution container 3 is conveyed to the developing unit 50 by the conveyer pump unit 11. An outlet of the conveyer pump unit 11 is connected to a solution pipe 49. When the level of the developing solution in the solution container 3 becomes too low, the developing solution is not supplied to the developing unit. Therefore, in the present embodiment, the preparatory developing solution stored in the preparatory solution container 3 is supplied to the solution container 3 when the level of the developing solution in the solution container becomes as low as a predetermined lower limit. Further, toner density of the developing solution in the solution container 3 tends to be concentrated over image forming operations. Therefore, the toner density is monitored by a density sensor (not shown) so that the carrier solution is supplied from the preparatory carrier solution container 7 if necessary.

As mentioned above, color density of an image to be formed depends on toner density of the developing solution. That is, the image is printed in higher density when the toner density of the developing solution is high, and in lower density when the toner density is low. In the wet type printer 100 in the present embodiment, the toner density in the developing solution in the solution container 3 is adjusted with the supplemental carrier solution from the preparatory carrier solution container 7 so that the toner density (i.e., the color density of the image) is maintained constant. More specifically, the developing solution in the solution container 3, as well as the developing solution in the preparatory solution container, is composed in a weight ratio of approximately 30% as toner and the remaining 70% as carrier solution.

The solution container 3 is provided with a stirring unit 4, which stirs the stored developing solution, and a lateral opening 6. The lateral opening 6 is connected to a pipe (not shown), which is further connected to an opening (not shown) provided on an extended line (not shown) of an axis of the screw 59 (see FIG. 1). The developing solution carried by the screw 59 is returned to the solution container 3 via the lateral opening 6.

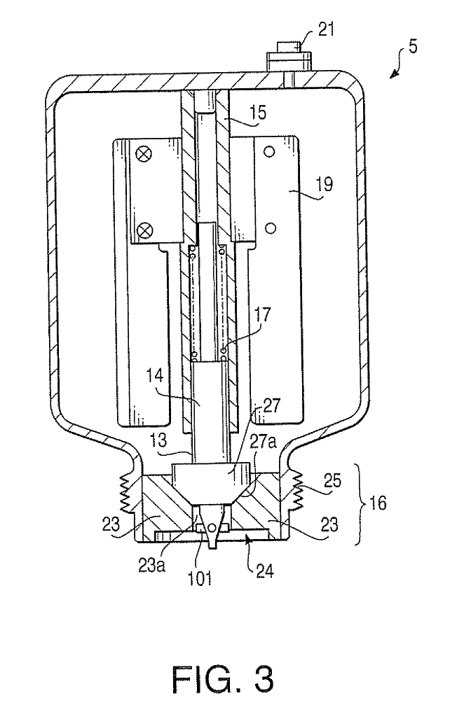

Hereinafter, the preparatory solution container 5 in the present embodiment will be described. The preparatory solution container 5 is threadably mounted to the receiver unit 8, which is fixedly mounted to a body of the wet type printer 100. The preparatory solution container 5 is removable from the receiver unit 8 (see FIGS. 2 and 3). FIG. 3 is an illustrative diagram of the preparatory container 5 of the wet type printer 100 being removed from the receiver unit 8 according to the embodiment of the present invention. However, in FIG. 3, the preparatory solution container 5 is shown in a position when the preparatory solution container 5 is mounted to the receiver unit 8. The preparatory solution container 5 includes a rotary shaft 13, paddle unit 19 that are coupled to the rotary shaft 13, an inlet 21, a container-side stopper 23. The inlet 21 is provided so that the air is introduced therethrough to the inside of the preparatory solution container 5 when the developing solution is aspirated by the supplier pump unit 9. The preparatory solution container 5 is mounted to the receiver unit 8 with a coupling portion 16. The rotary shaft 13 includes a drive force transmitting shaft 14, which transmits drive force provided externally from the wet type printer 100, and a hollow cylinder 15, wherein a part of the drive force transmitting shaft 14 is slidably inserted at a lower end of the hollow cylinder 15, and a spring 17, which applies downward expanding force to the inserted portion of the drive force transmitting shaft 14. An outer circumference of the coupling portion 16 is formed a threaded portion 25. The coupling portion 16 is formed an opening therein, through which the developing solution is aspirated. (Detail of the opening will be described hereinbelow.)

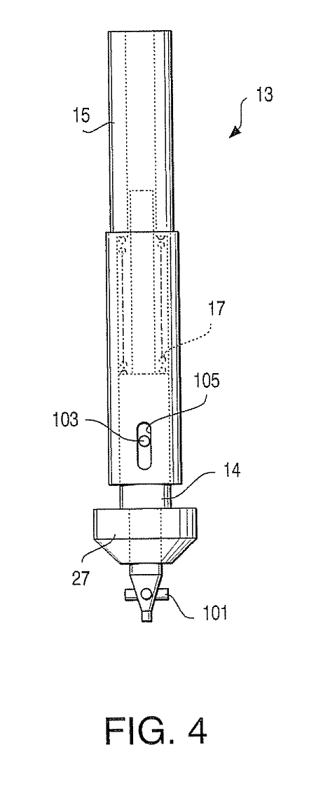

FIG. 4 is an enlarged side view showing the rotary shaft 13 of the preparatory container 5 according to the embodiment of the present invention. As mentioned above, a part of the drive force transmitting shaft 14 is slidably inserted into the hollow cylinder 15, and is provided with downward expanding force by the spring 17, which is in contact with the drive force transmitting shaft 14 at one end. The other end of the spring 17 provides the hollow cylinder 15 with upward expanding force. The drive force transmitting shat 14 includes a rotary shaft-side stopper 27, engaging pins 101, and a drive force transmitting pin 103. The rotary shaft-side stopper 27 is adapted to be in contact with the container-side stopper 23 when the drive force transmitting shaft 14 is depressed by the spring 17. The engaging pins 101 is adapted to engage with the receiver unit 8 when the preparatory solution container 5 is mounted to the receiver unit 8. It should be noted that the container-side stopper 23 is formed to have a shape of a cylinder, and an outer diameter thereof is configured to fit an inner diameter of the coupling portion 16 (see FIG. 3). Further, the container-side stopper 23 is provided with a through hole 23a, which is at a center and in parallel with an axial direction of the cylinder. The rotary shaft-side stopper 27 is partially inserted to the drive force transmitting shaft 14, and is formed as a circular cone with an axis corresponding to a rotation axis of the drive force transmitting shaft 14 with an apex portion thereof being removed, i.e., having a cross-sectional shape of an approximate circular truncated cone. A bevel surface 27a of the rotary shaft-side stopper 27 is in close contact with the container-side stopper 23. As the rotary shaft-side stopper 27 is sealed to the container-side stopper 23, the developing solution in the preparatory solution container 5 will not leak through the through hole 23a when the preparatory container 5 is not mounted to the receiver unit 8. The hollow cylinder 15 is provided with an elongated opening 105, through which a drive force transmitting pin 103 is inserted. The drive force transmitting pin 103 is adapted to be a spring pin, and is disposed in the elongated opening 105 when the drive force transmitting shaft 14 is inserted into the hollow cylinder 15. As the drive force transmitting shaft 14 is rotated, the drive force transmitting pin 103 becomes in contact with an inner edge of the elongated opening 105, and thereby the rotating force is transmitted to the hollow cylinder 15. The drive force transmitting pin 103 is capable of shifting in a longitudinal direction of the elongated opening 105.

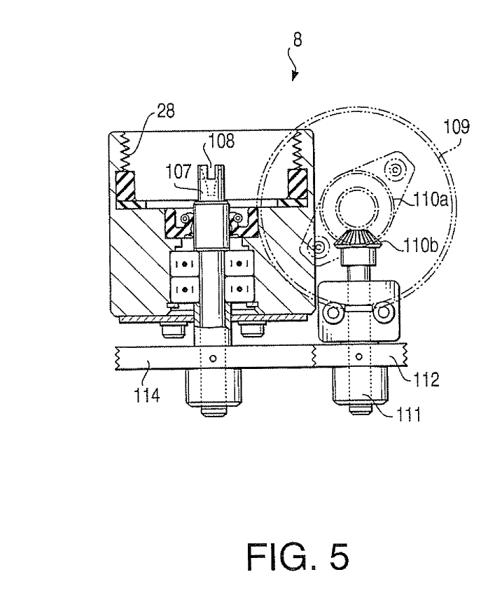

FIG. 5 is a cross-sectional side view showing a structure of the receiver unit 8, which is fixedly mounted to the body of the wet type printer 100 according to the embodiment of the present invention. The receiver unit 8 includes drive shafts 107, 111, gears 109, 112, and double-helical gears 110a, 110b. The drive shaft 107 is adapted to be coupled to the drive force transmitting shaft 14 when the preparatory solution container 5 is mounted to the receiver unit 8. The gear 109 is coupled to a drive source such as a drive motor (not shown) equipped in the developing unit 50 (see FIG. 1). The double-helical gear 110a is coupled to a common rotation axis of the gear 109, and is in engagement with the double-helical gear 110b. Further, the double-helical gear 110b is coupled to the drive shaft 111, which is coupled to the gear 112 in a vicinity to a lower end of the drive shaft 111. The receiver unit 8 is provided with a threaded portion 28, wherein the threaded portion 25 of the preparatory solution container 5 is screwed when the preparatory solution container 5 is mounted to the receiver unit 8. The receiver unit 8 is further provided with a gear 114 in a vicinity to a lower end of the drive shaft 107. As the gear 114 and the gear 112 are engaged with each other, rotating force of the drive shaft 111 is transmitted to the drive shaft 107 via the gears 114, 112. It should be noted that an upper end of the drive shaft 107 is formed an approximately conic shaped pit 108, which is coupled to a lower end portion of the drive force transmitting shaft 14 when the preparatory solution container 5 is mounted to the receiver unit 8.

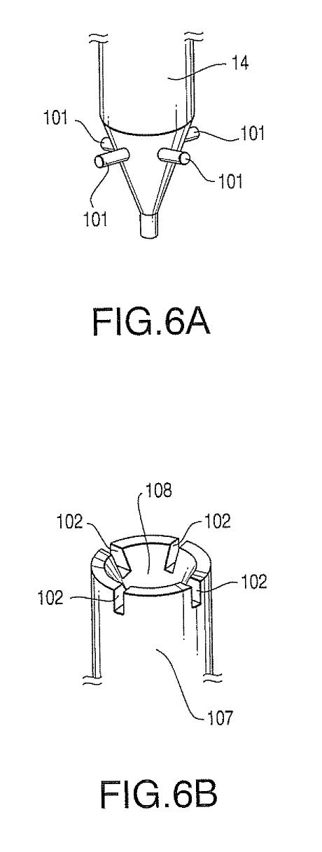

FIG. 6A is an enlarged perspective view of the lower end portion of the drive force transmitting shaft 14, and FIG. 6B is an enlarged perspective view of an upper end portion of the drive shaft 107 according to the embodiment of the present invention. As shown in FIG. 6A, four engaging pins 101 are provided at the lower end portion of the drive force transmitting shaft 14, and are arranged at 90 degrees with respect to each other in a plane that is perpendicular to the rotation axis of the drive force transmitting shaft 14. As shown in FIG. 613, four recessed portions 102 are formed on the upper end portion of the drive shaft 107, at positions that correspond to the engaging pins 101 of the drive force transmitting shaft 14. The engaging pins 101 are engaged with the recessed portions 102 respectively, so that the drive force transmitting shaft 14 and the drive shaft 107 are coupled, and the rotating force of the drive shaft 107 is securely transmitted to the drive force transmitting shaft 14. It should be noted that the number of the engaging pins 101 and the recessed portions 102 is not limited to four. For example, one engaging pin 101 that penetrates through the drive force transmitting shaft 14 may be provided at the positions corresponding to two of the above-mentioned four engaging pins 101, and two recessed portions 102 may be provided to the drive shaft 107 at positions corresponding to the one engaging pin 101.

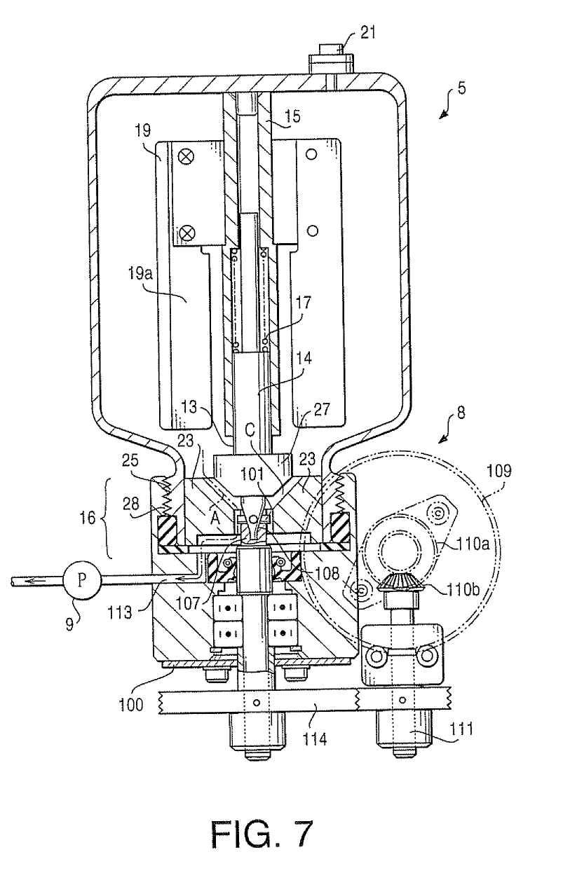

FIG. 7 is a cross-sectional side view showing a structure of the preparatory solution container 5 mounted to the receiver unit 8 according to the embodiment of the present invention. When the preparatory solution container 5 is mounted to the receiver unit 8 and the lower end portion of the drive force transmitting shaft 14 is pressed against the receiver unit 8, the spring 17 is contracted by the upper end portion of the drive force transmitting shaft 14. Thus, the rotary shaft-side stopper 27 is uplifted, and the rotary shaft-side stopper 27 is unsealed from the container-side stopper 23. A diameter of the through hole 23a of the container-side stopper 23 is configured to be greater than an outer diameter of the upper end portion of the drive shaft 107. Therefore, as the shaft-side stopper 27 is uplifted, a clearance C is formed between the container-side stopper 23 and the drive shaft 107, through which the developing solution exudes. The developing solution from the preparatory exuded from the preparatory solution container 5 thereafter reaches to an outlet portion 24, which is at a bottom of the container-side stopper 23, as the flow is indicated by a dotted arrow A. The receiver unit 8 is provided with a solution path 113 that leads the exuded developing solution to be aspirated by the supplier pump unit 9, and thereby transmitted to the solution container 3 (see FIG. 2).

When the preparatory solution container 5 is mounted to the receiver 8, the lower end portion of the drive force transmitting shaft 14 becomes in contact with the pit 108 of the drive shaft 107. It should be noted that heights of the threaded portion 25 of the preparatory solution container 5 and the threaded portion 28 of the receiver unit 8 in the present embodiment are configured to be substantial to uplift the rotary shaft-side stopper 27 from the container-side stopper 23 as the threaded portion 25 and the threaded portion 28 are screwed together. Further, as the rotary shaft-side stopper 27 is uplifted from the container-side stopper 23, the clearance C is formed between the rotary shaft-side stopper 27 and the container-side stopper 23, so that the preparatory developing solution in the preparatory solution container 5 can be supplied to an external unit (i.e., the solution container 3).

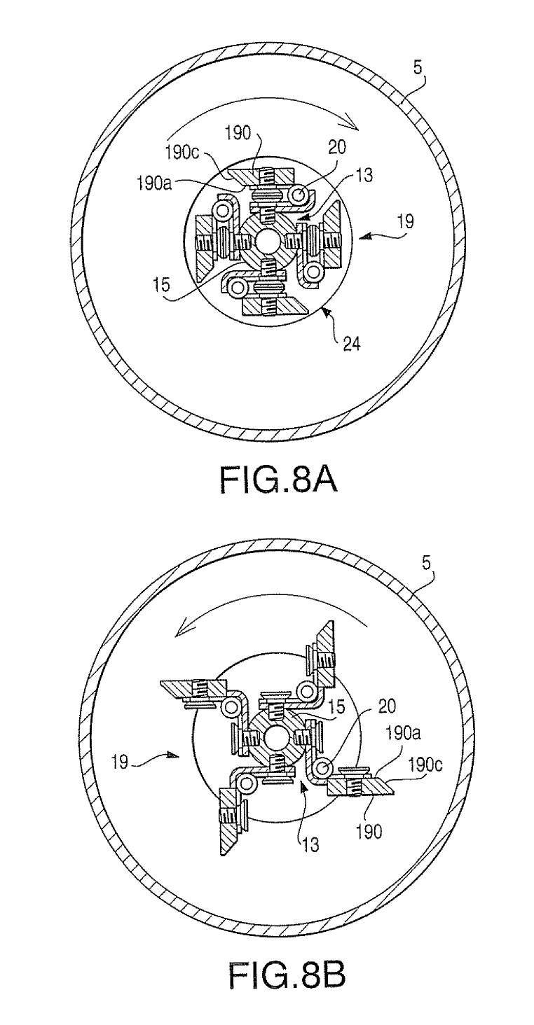

FIGS. 8A and 8B are cross-sectional top views showing an internal structure of the preparatory solution container 5 with a paddle unit 19 therein according to the embodiment of the present invention. The paddle unit 19 includes paddles 190 and hinges 20. As shown in FIG. 5A, the paddles 190 are in initial folded positions thereof. Each of the paddles 190 includes pressure receiving portions 190a and tapered pressure receiving portions 190c. From the folded position, each tapered pressure receiving portion 190c is adapted to receive pressure from the developing solution being stirred when the paddle unit 19 starts to rotate. Initially, the paddles 190 are folded to fit within an inner diameter of the coupling portion 16 of the preparatory solution container 5. More specifically, an outer diameter of a circular area in a plane perpendicular to the axis of the rotary shaft 13, wherein the folded paddles 190 fit, is configured to be smaller than the inner diameter of the coupling portion 16. With this configuration, the paddle unit 19 can be easily installed in the preparatory solution container 5 through the coupling portion 16. When each tapered pressure receiving portion 19c receives pressure from the developing solution to be stirred as the paddle unit 19 rotates in a counterclockwise direction in FIG. 8A, each paddle 19 is opened accordingly. That is, as the paddle unit 19 rotates in the counterclockwise direction, the tapered pressure receiving portions 190c receive pressure from the developing solution that is transitioned in a clockwise direction (as indicated by an arrow in FIG. 8A) with respect to the paddles 190. Further, as the pressure from the developing solution increases, the paddles 190 are rotated about the hinges 20 respectively and are fully opened as shown in FIG. 8B.

FIG. 8B is a cross-sectional top view showing the internal structure of the preparatory solution container 5 with the paddles 190 opened therein according to the embodiment of the present invention. The paddles 190 are fully opened, i.e., at approximately 90 degrees with respect to the initial folded positions, as the rotary shaft 13 rotate in the counterclockwise direction as indicated by an arrow in FIG. 8B. In the preparatory solution container 5 of the present embodiment, it is preferable that the paddles of the paddle unit 19 rotate in a greater circular area so that the developing solution in the preparatory solution container 5 is stirred substantially to have the toner therein to be evenly distributed and not to be deposited in the solution. Therefore, the paddle unit 19 with a greater outer diameter when the paddles 190 are fully opened is preferable. It should be noted that the paddle unit 19 in the present embodiment is adapted to have a greater outer diameter when in use, whilst the paddle unit 19 with the paddles 190 folded can be installed in the preparatory solution container 5 easily. It should be further noted that the paddles 190 can be folded when the rotary shaft 13 rotates in an opposite direction from the direction to unfold the paddles 190, i.e., the clockwise direction as indicated by the arrow in FIG. 8A, so that the paddle unit 19 can be taken out of the preparatory solution container 5 in case, for example, the paddle unit 19 requires to be replaced.

With the above-described configuration, additional developing solution can be supplied to the wet type printer 100 by replacing the preparatory solution container 5 to a new preparatory solution container when the level of the developing solution in the preparatory solution container 5 becomes low. Further, as the clearance C between the rotary shaft-side stopper 27 and the container-side stopper 23 is sealed as the preparatory solution container 5 is unscrewed from the receiver unit 8, the residual developing solution is not allowed to leak therethrough when the preparatory solution container 5 is removed from the receiver unit 8. Therefore, the body of the wet type printer 100 and/or hands of the operator are not contaminated by the developing solution during the replacing operation of the preparatory solution container 5. Furthermore, as the rotating force to stir the paddle unit 19 is provided from the drive motor equipped to one of the units of the wet type printer 100, no specific drive force dedicated to the paddle unit 19 is required, so that the wet type printer 100 can be designed in a more simple configuration.

Although the present invention has been described based on the foregoing embodiment, it is to be understood that the present invention is not limited thereto, but various modifications may be made without departing from the scope of the present invention.

The present disclosure relates to the subject matter contained in Japanese Patent Application No. 2005-139300, filed on May 12, 2005, which is expressly incorporated herein by reference in its entirety.

What is claimed is:

1. A wet type image forming apparatus, comprising:
a developing solution container;
a preparatory developing solution container, which is adapted to store developing solution to be supplied to the developing solution container; and
an attachment unit to which the preparatory developing solution container is attached,
wherein the preparatory developing solution container includes a coupling portion removably coupled to the attachment unit, a developing solution path being formed in the coupling portion to allow the developing solution to flow therein, a blocking system blocking the developing solution path, and a stirring unit stirring the developing solution in the preparatory developing solution container, and
wherein the attachment unit includes a releasing system to open the developing solution path blocked by the blocking system when the coupling portion of the preparatory developing solution container is coupled to the attachment unit.

2. The wet type image forming apparatus according to claim 1, wherein the blocking system includes a movable sealing member being adapted to block the developing solution path, and an expansive member being adapted to apply expanding force to the movable sealing member so that the movable sealing member with the expanding force blocks the developing solution path.

3. The wet type image forming apparatus according to claim 2, wherein the releasing system is adapted to shift the movable sealing member against the expanding force of the expansive member so that the developing solution path is opened.

4. The wet type image forming apparatus according to claim 1, wherein the releasing system is adapted to shift the movable sealing member against the expanding force of the expansive member so that the developing solution path is opened.

5. The wet type image forming apparatus according to claim 1,
wherein the stirring unit includes at least one paddle to stir the developing solution in the preparatory developing solution container, and a rotary shaft to which the at least one paddle is attached, and
wherein the at least one paddle is adapted to be unfolded according a rotation of the rotary shaft in one direction, and folded according to a rotation of the rotary shaft in an opposite direction.

6. The wet type image forming apparatus according to claim 5, wherein an outer diameter of a circular area in a plane perpendicular to an axis of the rotary shaft, within which the stirring unit with the paddles folded fit, is configured to be smaller than an inner diameter of the coupling portion.

7. The wet type image forming apparatus according to claim 1,
wherein the stirring unit includes at least one paddle to stir the developing solution in the preparatory developing solution container, and a rotary shaft to which the at least one paddle is attached, and
wherein the attachment unit includes a drive force transmitting system to transmit drive force generated in the wet type image forming apparatus to the rotary shaft.

8. The wet type image forming apparatus according to claim 7,
wherein the rotary shaft includes a first shaft having the at least one paddle attached thereto, a second shaft, of which an end portion is exposed from an opening formed in the coupling portion, being slidable in an axial direction of the first shaft, and an expansive member applying expanding force to the second shaft toward the opening
wherein the drive force transmitting system is adapted to engage with the second shaft and to press the second shaft in an axial direction of the second shaft against the expanding force from the expansive member when the preparatory developing solution container is attached to the attachment unit so that the drive force via the drive force transmitting system is transmitted to the rotary shaft.

9. The wet type image forming apparatus according to claim 8,
wherein the second shaft is provided with a sealing member being applied the expanding force by the expansive member to block the developing solution path, and
wherein the second shaft is shifted to open the developing solution path when the drive force transmitting system is engaged with the second shaft.

10. A developing solution container to store developing solution therein for a wet type image forming apparatus, comprising:
a coupling portion, which is removably coupled to an attachment unit of the wet type image forming apparatus;
a developing solution path, which is formed in the coupling portion to allow the developing solution to flow therein:
a blocking system, which is adapted to block the developing solution path; and
a stirring unit, which is adapted to stir the developing solution in the developing solution container,
wherein the developing solution path is blocked when the developing solution container is attached to the attachment unit of the wet type image forming appratus, and is opened when the developing solution container is removed from the attachment unit of the wet type image forming apparatus.

11. The developing solution container according to claim 10, wherein the blocking system includes a movable sealing member being adapted to block the developing solution path, and an expansive member being adapted to apply expanding force to the movable sealing member so that the movable sealing member with the expanding force blocks the developing solution path.

12. The developing solution container according to claim 10,
wherein the stirring unit includes at least one paddle to stir the developing solution in the developing solution container, and a rotary shaft to which the at least one paddle is attached, and
wherein the at least one paddle is adapted to be unfolded according a rotation of the rotary shaft in one direction, and folded according to a rotation of the rotary shaft in an opposite direction.

13. The developing solution container according to claim 12, wherein an outer diameter of a circular area in a plane perpendicular to an axis of the rotary shaft, within which the stirring unit with the paddles folded fit, is configured to be smaller than an inner diameter of the coupling portion.

14. The developing solution container according to claim 10,
wherein the stirring unit includes at least one paddle to stir the developing solution in the preparatory developing solution container, and a rotary shaft to which the at least one paddle is attached, and
wherein drive force generated in the wet type image forming apparatus is transmitted to the rotary shaft via the attachment unit of the wet type image forming apparatus.

15. The developing solution container according to claim 14,
wherein the rotary shaft includes a first shaft having the at least one paddle attached thereto, a second shaft, of which an end portion is exposed from an opening formed in the coupling portion, being slidable in an axial direction of the first shaft, and an expansive member applying expanding force to the second shaft toward the opening
wherein the second shaft is rotated by the drive force transmitted via the attachment unit of the wet type image forming apparatus by having the second shaft engaged with a drive force transmitting system of the wet type image forming apparatus when the developing solution container is attached to the attachment unit.

16. The developing solution container according to claim 15,
wherein the second shaft is provided with a sealing member being applied the expanding force by the expansive member to block the developing solution path, and
wherein the second shaft is shifted to open the developing solution path when the second shaft is engaged with the drive force transmitting system of the wet type image forming apparatus.
